(19) United States
(12) Patent Application Publication
(10) Pub. No.: US 2020/0285229 A1
(43) Pub. Date: Sep. 10, 2020

(54) METHOD AND SYSTEM FOR CONTROL OF AN UNMANNED AERIAL VEHICLE

(71) Applicant: George A. Miller, Dallas, TX (US)

(72) Inventor: George A. Miller, Dallas, TX (US)

(21) Appl. No.: 16/295,430

(22) Filed: Mar. 7, 2019

(51) Int. Cl. G05D 1/00; B64C 39/02; B64D 47/02; B64D 45/00

(52) U.S. Cl. CPC G05D 1/0022; B64C 39/024; B64D 47/02; B64D 45/00; B64C 2201/027; H04W 84/042; B64C 2201/108; B64C 2201/141; B64C 2201/146; B64D 2045/008; B64C 2201/042

(57) ABSTRACT

A vehicle controllable by an autonomous mode and an alternate mode is provided. The vehicle includes a body, one or more lights positioned on the body of the vehicle; and a processor. The processor is operable to be in signal communication with the one or more lights and the vehicle. The processor is configured to: receive an initial signal that the vehicle is being controlled by the autonomous mode or the alternate mode; actuate, when the vehicle is in the autonomous mode, one or more lights positioned on the vehicle to a first state; and actuate, when the vehicle is in the alternate mode, the one or more lights to a second state.

### CROSS-REFERENCE

This application is a continuation of patent application Ser. No. 15/933,107, which was filed on Mar. 22, 2018 and which claims priority to U.S. Provisional Patent Application No. 62/528,397, filed in the U.S. Patent and Trademark Office on Jul. 3, 2017. Each application is incorporated herein by reference in its entirety for all purposes.

### TECHNICAL FIELD

The present disclosure relates generally to systems to communicate a mode controlling a vehicle. In particular, the present disclosure relates to a system including one or more lights which communicate whether a vehicle is controlled by an autonomous mode or an alternate mode.

### BACKGROUND

Autonomous vehicles are vehicles under the control of automated driving systems. Autonomous vehicles can sense its environment and navigate without human input. Autonomous vehicles are programmed to maneuver in a predictable way to ensure safety, increase traffic flow, and provide mobility for children, the elderly, and/or the handicapped. Other drivers or persons in the area or law enforcement may want to know if a vehicle is controlled by an autonomous mode. Also, if the vehicle is controlled by an alternate mode, such as by human control, other drivers or law enforcement may want to know of such information. With such information, other drivers may know to be warier of the vehicle's movements. Further, with such information, law enforcement may better recreate any accidents.

### SUMMARY

An embodiment of the present disclosure, accordingly, provides an unmanned aerial vehicle (UAV). The UAV comprises: a main housing having and interior and an exterior; a motor that is secured to the housing, wherein the motor includes a stator and a rotor; a propeller that is secured to the rotor of the motor; a light housing that is secured to the main housing and visible on the exterior of the main housing, and wherein the light housing includes a lens that is at least partially transparent to visible spectrum light; a light that is secured within at least one of light housings, and wherein the light is configured to produce a first color and a second color; a controller that is secured within the interior of the main housing, wherein the controller includes a processor, and wherein the controller is configured to receive commands through a cellular network, and wherein the controller is configured to communicate with a network storage device over the cellular network, and wherein, when the controller receives a command to operate in an autonomous mode, the controller commands the light to emit the first color, and wherein, when the controller receives a command to operate in a manual mode, the controller commands the light to emit the second color.

In accordance with an embodiment of the present disclosure, the propeller further comprises a plurality of propellers.

In accordance with an embodiment of the present disclosure, wherein the controller is configured to communicate its position the cellular network to the network storage device.

In accordance with an embodiment of the present disclosure, the controller is configured to measure speed, and wherein the controller is configured to communicate the measured speed over the cellular network to the network storage device.

In accordance with an embodiment of the present disclosure, the controller further comprises a plurality of sensors, and wherein the controller is configured to issue an alert based on an impact indication triggered by at least one of the sensors.

In accordance with an embodiment of the present disclosure, the main housing further comprises: a central member; and a plurality of arms extending from the central member.

In accordance with an embodiment of the present disclosure, the motor further comprises a plurality of motors, wherein each motor is secured to at least one of the plurality of arms.

In accordance with an embodiment of the present disclosure, the propeller further comprises a plurality of propellers, wherein each propeller is secured to the rotor of at least one of the plurality of motors.

In accordance with an embodiment of the present disclosure, the central member has a top surface, and wherein the light is visible from the top surface.

In accordance with an embodiment of the present disclosure, the light housing further comprises a plurality of light housings, and wherein the light further comprises a plurality of lights.

In accordance with an embodiment of the present disclosure, the UAV comprises four arms, four motors, and four propellers.

In accordance with an embodiment of the present disclosure, a UAV is provided. The UAV comprises a central member having an interior and an exterior, wherein the exterior includes a top surface; a plurality of arms extending from the central members a plurality of hubs, wherein each hub is located at the distal end of at least one arm, wherein each hub includes: a motor with a rotor and stator, wherein the stator of the motor is secured in a substantially fixed position; and a propeller that is secured to the rotor of the motor; a light housing that is secured to the central member and visible on the top surface of central member, and wherein the light housing includes a lens that is at least partially transparent to visible spectrum light; a light that is secured within at least one of light housings, and wherein the light is configured to produce a first color and a second color; a controller having a processor and a plurality of sensors, wherein the controller is secured within the interior of the central member, and wherein the controller is configured to: operate in at least one of a remote-control mode and an autonomous mode; command the light to emit the first color in the remote-control mode and the second color in the autonomous mode; receive commands through a cellular network; communicate its position over the cellular network to a network storage device; determine speed; communicate the speed over the cellular network to a network storage device; and issue an alert based on a trigger event measured from at least one sensor.

In accordance with an embodiment of the present disclosure, the trigger event is an impact.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1A and IB are diagrams illustrating exemplary vehicles with exemplary systems installed therein according to the present disclosure;

FIG. 2 is a diagram illustrating a passenger vehicle with an installed system according to the present disclosure;

FIG. 3 is a diagram illustrating an airplane with an installed system according to the present disclosure;

FIG. 4 is a diagram illustrating a helicopter with an installed system according to the present disclosure;

FIG. 5 is a diagram illustrating a drone with an installed system according to the present disclosure;

FIG. 6 is a diagram illustrating a tram with an installed system according to the present disclosure;

FIG. 7 is a diagram illustrating a locomotive with an installed system according to the present disclosure;

FIGS. 8A-8D are diagrams illustrating exemplary shapes of lights to be used in a system according to the present disclosure;

FIGS. 9A-9C are diagrams illustrating exemplary shapes and positioning of lights to be used in a system according to the present disclosure;

FIGS. 10A-10B are diagrams illustrating exemplary shields to be used in a system according to the present disclosure; and

FIG. 11 is a flow chart of a method for using a system according to the present disclosure.

### DETAILED DESCRIPTION

Refer now to the drawings wherein depicted elements are, for the sake of clarity, not necessarily shown to scale and wherein like or similar elements are designated by the same reference numeral through the several views.

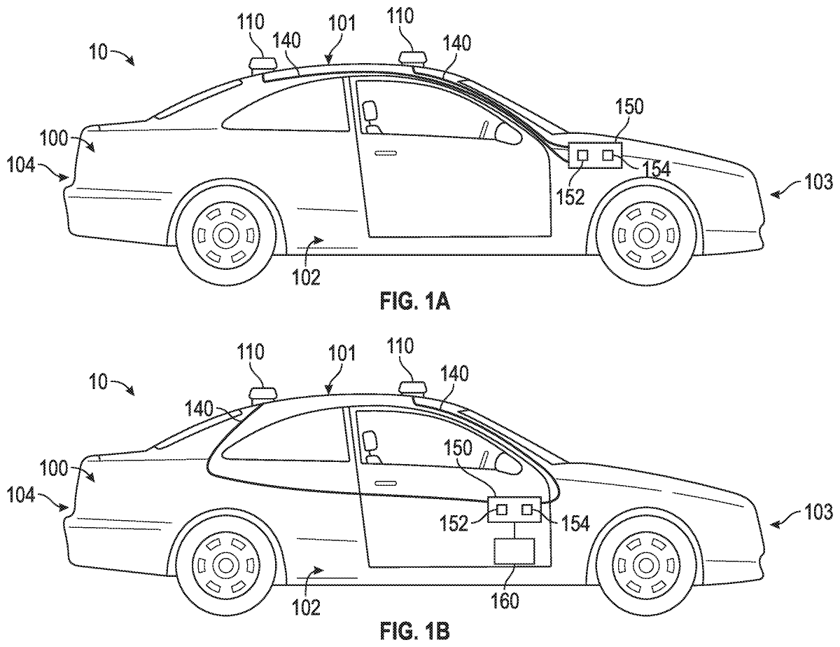

FIGS. 1 A and 1 B illustrate a vehicle 10. The vehicle 10 is controllable by an autonomous mode, for example by an autonomous driving system, and an alternate mode. In the autonomous mode, the vehicle 10 can sense its environment and navigate without user input. To do so, the vehicle 10 may include elements such as a processor to control the components to navigate the vehicle 10 and sensors such as lidar to sense its environment. The alternate mode can be a mode that is not the autonomous mode. For example, the alternate mode can be manual control by a user. Also, the vehicle 10 may be controllable by a third mode. The third mode can be remote control. For example, in the third mode, the vehicle 10 is being controlled by a user which is not in the vehicle but in another location. The vehicle 10 may also be controlled by any number of other modes or combination of modes.

The vehicle 10 has a body 100. The body 100 houses seating arrangements for users or passengers. The body 100 also houses mechanical, electrical, and/or chemical components of the vehicle 10. For example, the body 100 houses one or more of an engine, axles, frame, and fuel tank, along with batteries, sensors, and/or cables. The body 100 of the vehicle 10 has a top surface 101, first and second side surfaces 102, a front end 103, and a rear end 104. The body 100 can be made of steel, plastics, carbon fiber, any other suitable material for the body 100 of a vehicle 10, and any combination of such materials. While particular vehicle arrangements are shown, the vehicle can be in a variety of shapes as needed.

The present disclosure provides a system to alert those sharing roads, airways and other public or private spaces to be aware that a vehicle 10 does or does not have a human operator or that the human operator is or is not present in the vehicle 10. Additionally, as autonomous driving and piloting technologies advance and become a safer option, a system is needed to alert other persons, such as drivers or law enforcement, that the vehicle 10 is being controlled by a less predictable user.

As illustrated in FIGS. I A and I B, the system is installed in the vehicle 10. The system includes one or more lights 110 to be positioned on the body 100 of the vehicle I 0. The one or more lights 110 can be, for example, halogen lights, fluorescent lights, or LED lights. The system also includes a computing device 150 which includes a processor 152 and non-transitory storage medium 154. The computing device 150 can be positioned in any suitable location within the vehicle 10, for example in the dashboard, in the glove compartment, in the trunk, or in the center console. In at least one example, the system can be an independent system operable to be installed on the vehicle 10. In other examples, the system can be incorporated in the vehicle 10 when the vehicle IO is manufactured.

The non-transitory storage medium stores computer data. The computer data can include program logic or instructions which are executable by the processor 152. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computing device 150 or processor 152.

The computing device or controller 150 is operable to be in signal communication with the one or more lights 110 and the vehicle 10 by a communication network 140. The computing device 150 can be in signal communication with the one or more lights 110 and the vehicle 10 by wired or wireless communication network. A wired network may employ, for example, cables and/or optical fibers. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a wireless network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), North American/CEPT frequencies, radio frequencies, single sideband, radiotelegraphy, radioteletype (RTTY), Bluetooth, 802.11 b/g/n, or the like. A wireless network may include virtually any type of wireless communication mechanism by which signals may be communicated between devices between or within a network, or the like.

The processor 152 is configured to receive signals or commands_regarding the mode of the vehicle 10. For example, the processor 152 is configured to receive an initial signal that the vehicle 10 is being controlled by the autonomous mode or the alternate mode, or alternately the third mode. In at least one example, the initial signal may be received, when the vehicle 10 is initially started up. In other examples, the initial signal may be at other moments, such as when the system is first activated. When the vehicle 10 is m the autonomous mode, the one or more lights 110 are actuated to a first state. When the vehicle IO is in the alternate mode, the one or more lights 110 arc actuated to a second state which is different than the first state. Alternately, when the vehicle 10 is in the third mode, the one or more lights 110 are actuated to a third state, which is different than the first state and the second state. In at least one example, the states may be distinguished by color. The first state can be a first color, the second state can be a second color, and the third state can be a third color. For example, the first color can be blue, the second color can be gold, and the third color can be green. The first color, second color, and third color can be any combination of colors. The state, second state, and/or third state may each also be more than one color. For example, the first state may be white and blue stripes, the second state may be gold and purple stripes, and the third state may be green and orange stripes. In at least one example, the states may be distinguished by pattern. The first state can be a first pattern, the second state can be a second pattern, and the third state can be a third pattern. For example, the first pattern can be a persistent light where the light maintains a consistent intensity, the second pattern can be a flashing light pattern which can be equal lengths of time in an on state and an off state, and the third pattern can be a dash-dot light pattern where the light is in an on state for a first time followed by an off state which is then followed by an on state for a second time shorter than the first time. The first pattern, second pattern, and third pattern can be any combination of patterns. In other examples, the first state can be the one or more lights 110 being in an off state, and the second state is the one or more lights 110 being in an on state. Alternately, the first state can be the one or more lights 110 being in an on state, and the second state is the one or more lights 110 being in an off state. As such, it can be determined by the state of the one or more lights 110 whether the vehicle 10 is in the autonomous mode, the alternate mode, or the third mode.

Additionally, the processor 152 is configured to receive a transition signal or transition command that the vehicle 10 has transitioned or is transitioning from the autonomous mode to the alternate mode. When the vehicle 10 has transitioned from the autonomous mode to the alternate mode, the one or more lights 110 are actuated to transition from the first state to the second state. When the processor 152 receives a transition signal that the vehicle 10 has transitioned from the alternate mode to the autonomous mode. the one or more lights 110 can be actuated to transition from the second state to the first state. Also, the processor 152 can receive a transition signal that the vehicle 10 has transitioned to the third mode, and the one or more lights 110 are actuated to the third state.

Along with the one or more lights 110, one or more speakers can be positioned on the vehicle 10 and coupled with the processor 152. The speakers can emanate, when the vehicle 10 is in the alternate mode or in the third mode, a sound. The sound can be an alarm, one beep, or a sequence of beeps, a speaking voice, or any other suitable auditory notification.

As illustrated in FIG. I B, the system can additionally include a memory storage 160. The memory storage 160 is in signal communication with the computing device 150. In at least one example, the memory storage 160 is included in the computing device 150. The memory storage 160 can be RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computing device 150 or processor 152. Also, memory storage 160 can be cloud storage. When the vehicle IO is in the autonomous mode, the processor 152 records data to the memory storage. The data can include, for example, time that the vehicle 10 is in the autonomous mode, length of time that the vehicle 10 is in the autonomous mode, location of the vehicle 10, path of the vehicle 10, and/or velocity of the vehicle 10. Also, when the vehicle 10 is in the alternate mode, the processor 152 records data to the memory storage, which can include, for example, time that the vehicle 10 is in the alternate mode, length of time that the vehicle 10 is in the alternate mode, location of the vehicle 10, path of the vehicle 10, and/or velocity of the vehicle 10. Similarly, when the vehicle 10 is in the third mode, the processor 152 can record data to the memory storage, which can include, for example, time that the vehicle 10 is in the third mode, length of time that the vehicle 10 is in the third mode, location of the vehicle 10, path of the vehicle 10, and/or velocity of the vehicle 10. The data can be retrieved from the memory storage 160 by any suitable retrieval method, for example by wireless communication with the memory storage 160 such as Bluetooth, transmitted to the cloud, or by wired communication such as USB. The memory storage 160 may be protected by a compression-resistant and/or water-resistant casing. As such, the data can be retrieved by parties such as insurance companies and/or law enforcement to facilitate the investigation of accidents and incidents. The data can also be utilized for safety maximization uses.

In at least one example, the system can inform persons in the vicinity of the vehicle 10 whether the vehicle 10 is occupied or generate an alert. The function can assist law enforcement and first responders in assessing accident scene triage and response. For example, the processor 152 can actuate at least one of the one or more lights 110 to an occupied mode or an unoccupied mode. The occupied mode or the unoccupied mode may be separate from the first mode, the second mode, and the third mode. For example, the occupied mode and the unoccupied mode may be actuated for lights 110 that are not the lights 110 being used for the first mode, the second mode. and the third mode. In other examples, the same lights 110 may be used for all of the modes. In at least one example, the occupied or unoccupied modes may be constantly actuated. In other examples, the occupied or unoccupied modes are actuated by a trigger event. Trigger events can be, for example, deployment of an air bag or any other accident indication (e.g., impact indication) triggered by internal and/or external sensors of a vehicle 10.

The occupied mode and the unoccupied mode can be different than the first mode, the second mode, or the third mode. In at least one example, the occupied mode and the unoccupied mode can be the same as the first mode, the second mode, or the third mode. The occupied mode can be an occupied color, and the unoccupied mode can be an unoccupied color. For example, the occupied color can be orange, and the unoccupied color can be pink. Any suitable color can be used to represent the occupied mode and the unoccupied mode. Also, the occupied mode can be an occupied pattern, and the unoccupied mode can be an unoccupied pattern. For example, the occupied pattern can be in the on state, and the unoccupied mode can be in the off state. Other patterns can be flashing lights, persistent light, dash-dot pattern, or any other suitable pattern to distinguish between the occupied pattern and the unoccupied pattern. Additionally or alternately, the occupied mode can be a sound emanating from the one or more speakers of the vehicle 10.

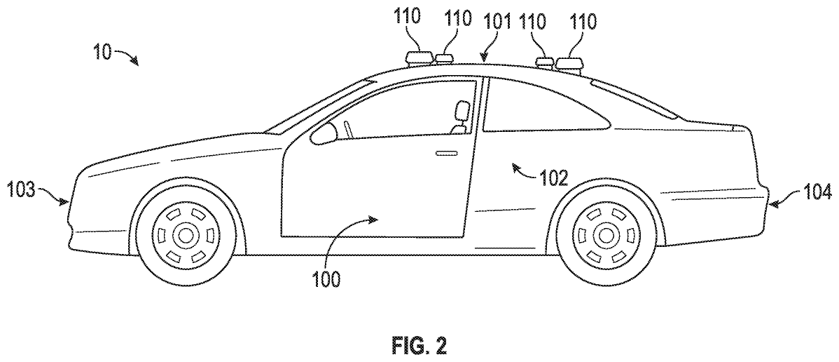

The one or more lights 110 are positioned at locations of visibility on the outside of the vehicle 10. As such, other persons in the area can have visible alerts as to the mode of the vehicle 10. The positioning of the one or more lights 110 may vary depending on the type of vehicle 10. The one or more lights 110 are positioned at locations of visibility to be visible at night from substantially all angles of the vehicle 10 within about 600 feet. All angles of the vehicle 10 include height, distance, and location in relation to the vehicle 10. As such, the one or more lights 110 should be visible, without obstruction, within a spherical area where the vehicle 10 is the center of the spherical area. The spherical area can have a radius of about 600 feet. The vehicle 10 can be, for example, a passenger vehicle, a livery vehicle, a delivery vehicle, a bus, an 18-wheeler, a drone (for example for delivery, surveillance, and/or military purposes), a helicopter, a tram, a locomotive, an air taxi, a watercraft, agriculture equipment, lawn care equipment, a data gathering apparatus, or an airplane. FIGS. 2-7 illustrate examples of different vehicles 10 and exemplary locations to position the one or more lights 110. While exemplary vehicles are shown, the vehicle can be in a variety of shapes as needed.

As illustrated in FIG. 2, the vehicle 10 is a passenger vehicle. The one or more lights 110 are positioned on the top surface 1010f the vehicle 10. At least one of the lights 110 is positioned proximate a front end 103 of the body 100 and at least one of the lights 110 is positioned proximate a rear end 104 of the body 100. Also, at least one of the lights 110 can be positioned proximate the first and second side surfaces 102. For example, the one or more lights 110 can be positioned about four locations on the top surface 1010f the body 100: front-right, front-left, rear-right, and/or rear-left. One or more lights 110 can also be positioned on at least one of the first and second side surfaces 102 of the body 100. As such, the lights 110 can be easily visible to persons close to the vehicle 10 who may not have sight of the top surface of the vehicle 10.

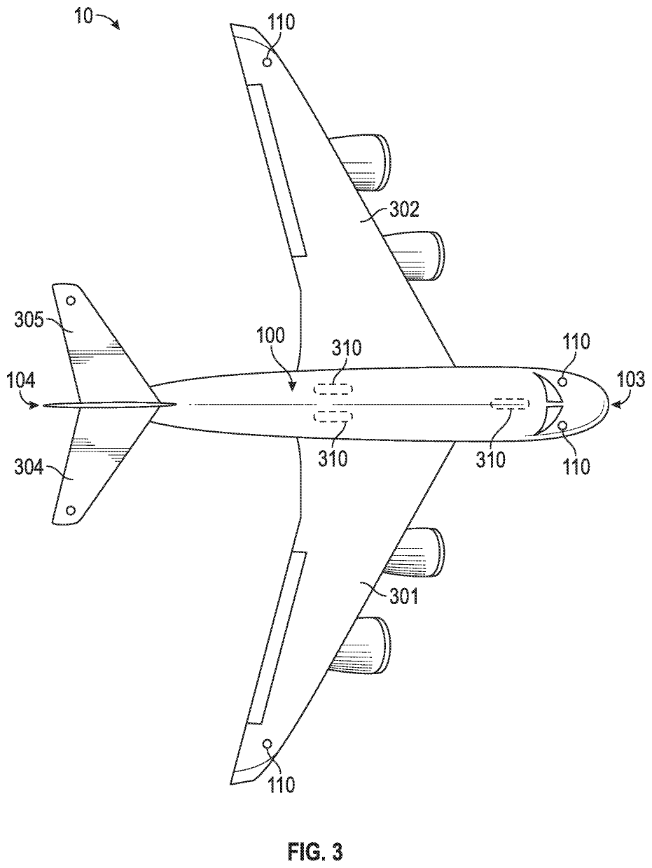

As illustrated in FIG. 3, the vehicle 10 is an airplane. The airplane can have a body 100 with a front end 103, a rear end 104, a tail 404, first and second wings 301, 302, landing gear 310, and/or first and second stabilizers 304, 305. The one or more lights 110 are positioned at locations of visibility on the airplane. For example, locations can include the first and second wings 301, 302, the first and second stabilizers 304, 305, proximate the front end 103 of the vehicle 10, the landing gear 310, and/or any combination of the locations. FIG. 3 shows the lights 110 positioned on top surfaces of the airplane. Additionally or alternately, the lights 110 may be positioned on bottom surfaces of the airplane.

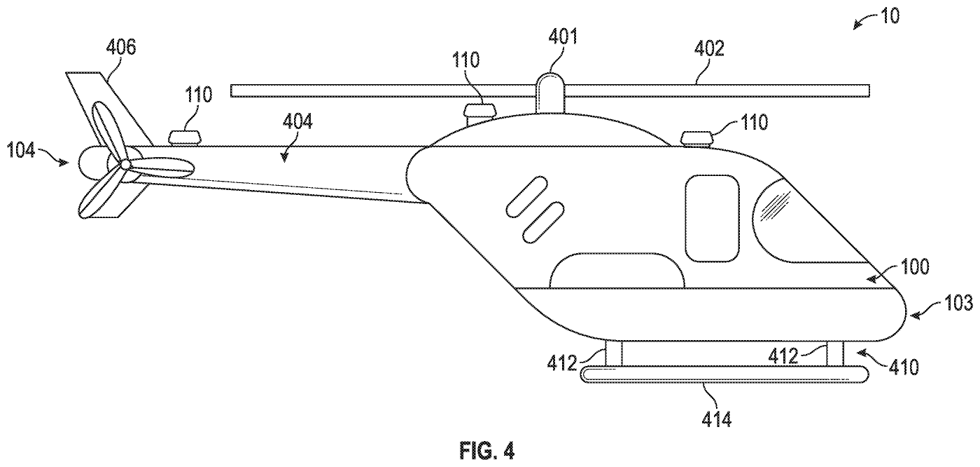

As illustrated in FIG. 4, the vehicle 10 is a helicopter. The helicopter can have a body 100 which includes a tail 404, a rudder 406, a mast 401, a plurality of blades 402, a front end 103, a rear end 104, and/or landing gear 410. The landing gear 410 can include a plurality of legs 412 and/or cross-bars 414. The one or more lights 110 are positioned at locations of visibility on the helicopter. For example, locations can include the mast 401, on the top surface 1010f the body 100, proximate the front end 103, proximate the rear end 104, on the tail 404, on the rudder 406, on the landing gear 410, and/or any combination of the locations. FIG. 4 shows the lights 110 positioned on top surfaces of the helicopter. Additionally or alternately, the lights 110 may be positioned on bottom surfaces of the helicopter.

As illustrated in FIG. 5, the vehicle 10 is a drone or unmanned aerial vehicle. The drone can have a body 100. The body 100 in this example has a housing with a generally rectangular central member with arms extending from each corner. At the distal end of each arm, there is a hub that includes a motor (whose stator is secured to the housing). A blade or propeller 501 is also secured to the rotor of motor in this example. The one or more lights 110 are positioned at locations of visibility on the drone. For example, locations can include the top surface 101 of the body 100 (or central member), the lower surface (not shown) of the body 100, the side surfaces (not shown) of the body 100, and/or any combination of the locations. FIG. 5 shows the lights 110 positioned on top surfaces of the drone. Additionally or alternately, the lights 110 may be positioned on bottom surfaces of the drone.

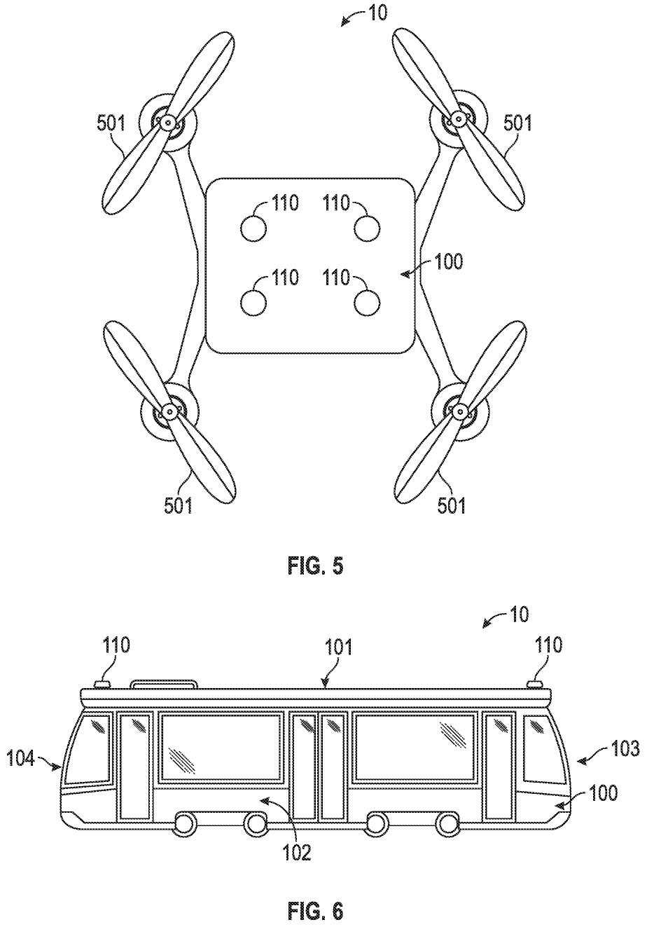

As illustrated in FIG. 6, the vehicle 10 is a tram. The tram can have a body 100 with a top surface 101, a front end 103, a rear end 104, and side surfaces 102. The one or more lights 110 are positioned at locations of visibility on the tram. For example, locations can include the top surface 101, proximate the front end 103, proximate the rear end 104, proximate the side surfaces 102, on the side surfaces 102, and any combination of the locations.

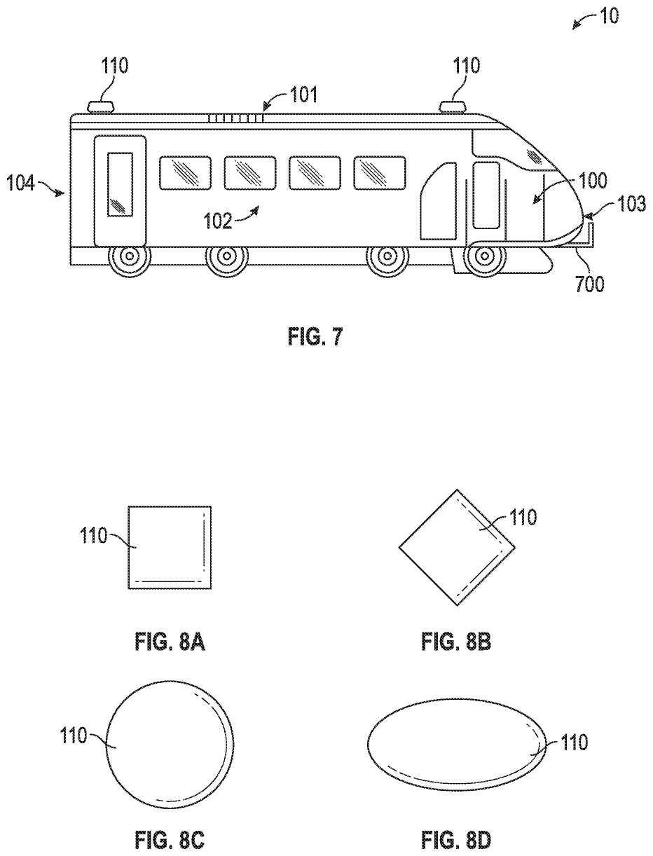

As illustrated in FIG. 7, the vehicle 10 is a locomotive. The locomotive includes an engine and one or more cars. The locomotive can have a body 100, a top surface 101, side surfaces 102, a front end 103, a rear end 104, and/or a cow catcher 700. The one or more lights 110 are positioned at locations of visibility on the locomotive. For example, locations can include the top surface 101, proximate the front end 103, proximate the rear end 104, proximate the side surfaces 102, on the side surfaces 102, on the cow catcher 700, and/or any combination of the locations.

FIGS. 8A-8D illustrate exemplary shapes of lights 110 to be used in a system. For example, the lights 110 can be substantially a square or rectangular as illustrated in FIG. 8A. As illustrated in FIG. 8B, the lights 110 can be substantially a diamond. As illustrated in FIG. 8C, the lights 110 can be substantially circular. As illustrated in FIG. 8D, the lights 110 can be substantially ovoid. Any other suitable shape of the lights 110 can also be utilized. Also, any combination of shapes of the lights 110 can be utilized. For example, the lights 110 proximate the front end of the vehicle 10 can be rectangular while the lights 110 proximate the rear end of the vehicle 10 can be circular.

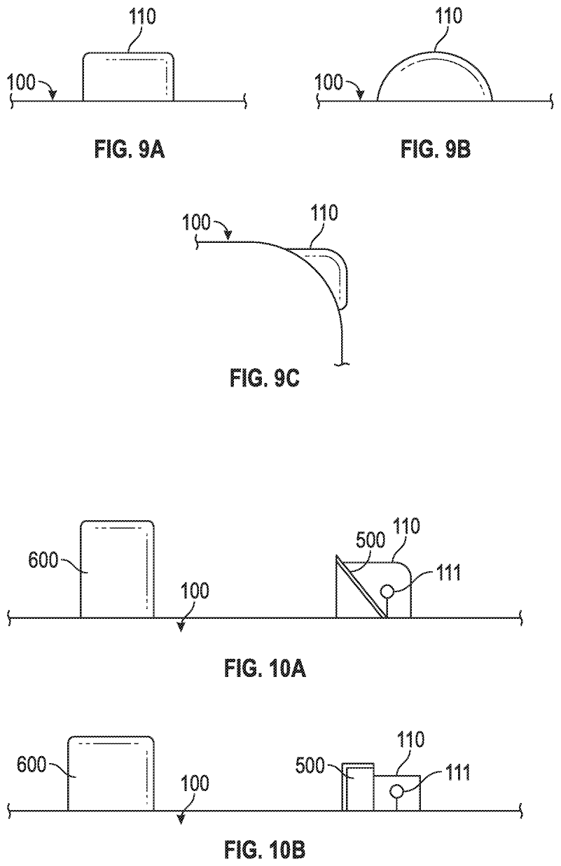

FIGS. 9A-9C illustrate exemplary shapes and positioning of lights 110 to be used in a system. FIGS. 9A-9C show exemplary lights 110 from a side view. In FIG. 9A, the light 110 is substantially a rectangular shape which projects from an external surface of the body 100 of the vehicle 10. In FIG. 9B, the light 110 is substantially a circular or semi-circular shape which projects from an external surface of the body 100 of the vehicle 10. In FIG. 9C, the light 110 is recessed in to the body 100 of the vehicle 10. The light 110 in FIG. 9C is substantially a rectangular shape and extends from the body 100 of the vehicle 10 a predetermined distance. While FIGS. 9A-9C illustrate exemplary shapes and positions of the lights 110, the shapes and positions can be any suitable shape, position, and combination thereof as desired or required by code or law. Also, the shapes and positions of the lights 110 ensure that the lights 110 are visible to persons around the vehicle 10. The lights 110 can be coupled to the vehicle 10 by fasteners, for example adhesives, screws, bolts, clips, and/or any suitable fastener to couple the light 110 to the body 100 of the vehicle 10.

The vehicle 10 may have sensors 600 which enable the vehicle 10 to sense its environment. Sensors 600 can be, for example, lidar, radar, electromagnetic sensors, and/or any other suitable sensors. The sensors 600 may be positioned on the top surface, the first and second side surfaces, the front end, and/or the rear end of the vehicle 10. In at least one example, the sensors 600 may protrude from the vehicle 10 and/or the sensors 600 may be recessed in the surfaces of the vehicle 10. To reduce or prevent interference with the sensors 600, the system may include a shield 500. The shield 500 can be made of a material such as plastic or metal to reduce light from the one or more lights 110 in one or more directions to prevent interference with the sensors 600. The shield 500 can be opaque. In at least one example, the shield 500 can be reflective to direct light away from the sensors 600. The shield 500 can be positioned between the lights 110 and the sensors 600.

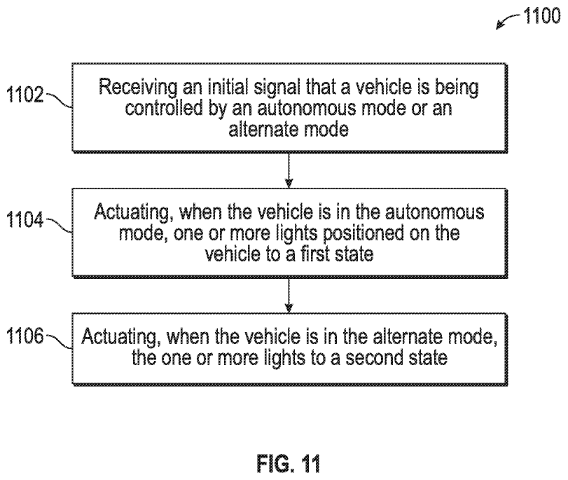

As illustrated in FIG. 10A, the shield 500 is provided within the light 110 and is positioned between the light source 111 and the sensor 600. The shield 500 in FIG. 10A is diagonal such that the amount of light in the direction of the sensor 600 is reduced or minimized. As illustrated in FIG. 10B, the shield 500 is provided separately from the light 110. The shield 500 is positioned between the light source 111 and the sensor. The shield 500 in FIG. 10B has substantially an L shape and extends above the light source 111 such that the light in the direction of the sensor 600 is reduced or minimized. The shape and orientation of the shield 500 can be any suitable shape and orientation so long as the light from the lights 110 in the direction of the sensors 600 is reduced or minimized. Also, the shield 500 is positioned such that the functionality of the sensor 600 is not impacted. As such, the shield 500 prevents the light emitting from the one or more lights 110 from interfering with the sensors 600 while maintaining the function of the sensors 600 to navigate the vehicle 10.

Referring to FIG. 11, a flowchart is presented in accordance with an example embodiment. The method 1100 is provided by way of example, as there are a variety of ways to carry out the method. The method 1100 described below can be carried out using the configurations illustrated in FIG. 11, for example, and various elements of these figures are referenced in explaining example method 1100. Each block shown in FIG. 11 represents one or more processes, methods or subroutines, carried out in the example method 1100. Furthermore, the illustrated order of blocks is illustrative only and the order of the blocks can change according to the present disclosure. Additional blocks may be added or fewer blocks may be utilized, without departing from this disclosure. The example method 1100 can begin at block 1102.

At block 1102, an initial signal is received by the processor that a vehicle is being controlled by an autonomous mode or an alternate mode. The alternate mode can be, for example, manual control by a user. The initial signal can be provided by the vehicle, for example a processor in the vehicle. In at least one example, the initial signal can be provided when the vehicle is turned on. In at least one example, the initial signal can also inform that the vehicle is being controlled by a third mode. The third mode can be, for example, remote control (for example, by a non-proximate human operator as opposed to any autonomous control whether the autonomous control is located in the vehicle or machine or by a remote system).

At block 104, when the vehicle is in the autonomous mode, one or more lights positioned n the vehicle are actuated to a first state. The first state can be, for example, a first color, a first pattern, an on state, or an off state.

At block 1106, when the vehicle is in the alternate mode, the one or more lights are actuated to a second state. The second state can be, for example, a second color, a second pattern, an off state, or an on state. The second state can be distinguished from the first state.

When the vehicle is in the third mode, the one or more lights can be actuated to a third state which can be, for example, a third color or a third pattern. The third state can be distinguished from both the first state and the second state. As such, the one or more lights can alert persons in the vicinity of the vehicle that the vehicle is in the autonomous mode, the alternate mode, or the third mode.

Additionally, the processor can receive a transition signal that the vehicle has transitioned from the autonomous mode to the alternate mode, and the one or more lights are actuated from the first state to the second state. Similarly, the processor can receive a transition signal that the vehicle has transitioned from the alternate mode to the autonomous mode, and the one or more lights are actuated from the second state to the first state. In at least one example, the processor can receive a transition signal that the vehicle has transitioned to the third mode, after which the one or more lights are actuated to the third state.

In at least one example, the processor can record, when the vehicle is in the autonomous mode, data to a memory storage. The data can include at least one of time that the vehicle is in the autonomous mode, alternate mode, or third mode, length of time that the vehicle is in the autonomous mode, alternate mode, or third mode, path of the vehicle, and/or velocity of the vehicle. As such, persons such as law enforcement or insurance companies are able to better recreate and understand the situation that may have led, for example, to an accident.

In at least one example, when the vehicle is in the alternate mode or the third mode, a sound can emanate from one or more speakers. As such, persons around the vehicle can be alerted that the vehicle is in the autonomous mode, the alternate mode, or the third mode and can react to the vehicle accordingly. Notably, persons around the vehicle where the vehicle is not in a direct line of sight can be alerted.

It is noted that the embodiments disclosed are illustrative rather than limiting in nature and that a wide range of variations, modifications, changes, and substitutions are contemplated in the foregoing disclosure and, in some instances, some features of the present disclosure may be employed without a corresponding use of the other features. Accordingly, it is appropriate that the appended claims be construed broadly and in a manner consistent with the scope of the disclosure.

1. An unmanned aerial vehicle (UAV) comprising:
a main housing having and interior and an exterior;
a motor that is secured to the housing, wherein the motor includes a stator and a rotor;
a propeller that is secured to the rotor of the motor;
a light housing that is secured to the main housing and visible on the exterior of the main housing, and wherein the light housing includes a lens that is at least partially transparent to visible spectrum light;
a light that is secured within at least one of light housings, and wherein the light is configured to produce a first color and a second color;
a controller that is secured within the interior of the main housing, wherein the controller includes a processor, and wherein the controller is configured to receive commands through a cellular network, and wherein the controller is configured to communicate with a network storage device over the cellular network, and wherein, when the controller receives a command to operate in an autonomous mode, the controller commands the light to emit the first color, and wherein, when the controller receives a command to operate in a manual mode, the controller commands the light to emit the second color.

2. The UAV of claim 1, wherein the propeller further comprises a plurality of propellers.

3. The UAV of claim 1, includes wherein the controller is configured to communicate its position the cellular network to the network storage device.

4. The UAV of claim 3, wherein the controller is configured to measure speed, and wherein the controller is configured to communicate the measured speed over the cellular network to the network storage device.

5. The UAV of claim 3, wherein the controller further comprises a plurality of sensors, and wherein the controller is configured to issue an alert based on an impact indication triggered by at least one of the sensors.

6. The UAV of claim 4, wherein the main housing further comprises:
a central member; and
a plurality of arms extending from the central member.

7. The UAV of claim 4, wherein the motor further comprises a plurality of motors, wherein each motor is secured to at least one of the plurality of arms.

8. The UAV of claim 5, wherein the propeller further comprises a plurality of propellers, wherein each propeller is secured to the rotor of at least one of the plurality of motors.

9. The UAV of claim 6, wherein the central member has a top surface, and wherein the light is visible from the top surface.

10. The UAV of claim 7, wherein the light housing further comprises a plurality of light housings, and wherein the light further comprises a plurality of lights.

11. The UAV of claim 8, wherein the UAV comprises four arms, four motors, and four propellers.

12. A UAV comprising:
a central member having an interior and an exterior, wherein the exterior includes a top surface;
a plurality of arms extending from the central members
a plurality of hubs, wherein each hub is located at the distal end of at least one arm, wherein each hub includes:
a motor with a rotor and stator, wherein the stator of the motor is secured in a substantially fixed position; and
a propeller that is secured to the rotor of the motor;
a light housing that is secured to the central member and visible on the top surface of central member, and wherein the light housing includes a lens that is at least partially transparent to visible spectrum light;
a light that is secured within at least one of light housings, and wherein the light is configured to produce a first color and a second color;
a controller having a processor and a plurality of sensors, wherein the controller is secured within the interior of the central member, and wherein the controller is configured to:
operate in at least one of a remote-control mode and an autonomous mode;
command the light to emit the first color in the remote-control mode and the second color in the autonomous mode;
receive commands through a cellular network;
communicate its position over the cellular network to a network storage device;
determine speed;
communicate the speed over the cellular network to a network storage device; and
issue an alert based on a trigger event measured from at least one sensor.

13. The UAV of claim 12, wherein the trigger event is an impact.
